(19) United States
(12) Patent Application Publication
(10) Pub. No.: US 2024/0316578 A1
(43) Pub. Date: Sep. 26, 2024

(54) Rotary Atomizer

(71) Applicant: Industra GmbH, Heusenstamm (DE)

(72) Inventors: Sebastian Planert, Heusenstamm (DE); Patrick Planert, Heusenstamm (DE)

(21) Appl. No.: 18/186,268

(22) Filed: Mar. 20, 2023

(51) Int. Cl. B05B 3/10

(52) U.S. Cl. CPC B05B 3/1042; B05B 3/1014

(57) ABSTRACT

The invention relates to a rotary atomizer (1) for coating components comprising a bell cup shaft (3) and a spray bell (4) that is regionally insertable into the bell cup shaft (3) and releasably attached to the bell cup shaft (3). The spray bell (4) includes at least one ferromagnetic element (11, 18) or at least one permanent magnetic element (7) and the bell cup shaft (3) includes at least one permanent magnetic element (7) or at least one ferromagnetic element (11, 18), which are arranged in relation to one another such that the ferromagnetic element (11, 18) and the permanent magnetic element (7) exert a magnetic retaining force on one another acting parallel to the axis of rotation of the bell cup shaft (3) in order to releasably retain the spray bell (4) on the bell cup shaft (3). A particularly secure attachment can be achieved by the bell cup shaft (3) having a conical receiving portion (5) facing the spray bell (4) and the spray bell (4) having a conical insertion portion (9) facing the bell cup shaft (3).

The invention relates to a rotary atomizer for coating components or workpieces with a coating agent, in particular paint.

Such rotary atomizers have many advantages and are used, for example, in painting facilities for motor vehicles. Known rotary atomizers include a bell cup shaft and a spray bell that is releasably attached to the bell cup shaft. The spray bell is attached to or on the bell cup shaft, which is driven at high speed by a compressed air turbine, for rotation therewith. For this purpose, the spray bell is often releasably connected to the bell cup shaft by means of a threaded connection to enable disassembling it. However, high speeds of up to 80,000 rpm and more (high-speed rotation bell) require a particularly secure attachment of the spray bell to the bell cup shaft in order to prevent unintentional detachment or release.

As an alternative to a threaded connection between the spray bell and the bell cup shaft, attaching a spray bell to the bell cup shaft by means of a plurality of magnetic pins is known from DE 10 2017 212 480 A1. For this purpose, the bell cup shaft made from a steel material includes a plurality of radial bores distributed over its circumference, in each of which a magnetic pin is arranged. The spray bell is formed with a complementary inner groove into which the permanent magnetic pins are pressed by centrifugal force during rotation of the bell cup shaft. When the bell cup shaft is stationary or not rotating, the magnetic pins retract into the shaft bores due to magnetic restoring forces in such a way that the spray bell can be easily assembled and disassembled by fitting and removing it. The magnetic properties of the magnetic pins are not used for bell attachment but for restoration and prevent it from falling out of the radial shaft bores. Even if this known solution is advantageous during operation, i. e. when the shaft is rotating, there is a risk that the spray bell, which is very susceptible to damage, can fall off the shaft when the shaft is stationary.

Other spray bells that are attachable to a shaft by means of magnetic force are known from DE 10 2004 032 045 A1 and DE 601 27 655 T2.

Another releasable magnetic attachment is proposed in EP 1 711 269 B1. Therein, the releasable attachment is achieved by magnetic elements that are arranged in a stationary housing of the rotary atomizer, i. e. not rotating with the shaft and the spray bell, and interact with a ferromagnetic ring integrated in the spray bell to pull a conical portion of the spray bell axially into a corresponding conical portion of the bell cup shaft. This design causes the spray bell to be initially retained on the housing for rotation therewith due to the magnetic force, which also securely prevents the spray bell from falling down unintentionally when the shaft is at a standstill. In this known solution, the spray bell (together with the shaft) is lifted off the housing slightly axially by means of compressed air, so-called bearing air, in order to enable the desired rotatability of the spray bell. In operation, this solution requires utilization of almost 200 NL of bearing air per minute and an increased complexity of control in order to keep the spray bell in a floating state by means of the bearing air counteracting the magnetic force. The high air consumption negatively impacts the operating costs.

It is the object of the invention to provide a rotary atomizer comprising a releasable bell cup that overcomes such disadvantages associated with the prior art.

This object is attained by a rotary atomizer having the features of claim 1.

According to one aspect of the present invention, the rotary atomizer for coating components includes a bell cup shaft and a spray bell that is regionally insertable into the bell cup shaft and releasably attached to the bell cup shaft. The spray bell includes at least one ferromagnetic element or at least one permanent magnetic element and the bell cup shaft includes at least one permanent magnetic element or at least one ferromagnetic element, which are arranged in relation to one another such that the ferromagnetic element and the permanent magnetic element exert a magnetic retaining force on one another acting parallel to the axis of rotation of the bell cup shaft in order to releasably retain the spray bell on the bell cup shaft. According to the invention, a particularly secure and easy-to-use connection is achieved by the spray bell being centered and fastened in the bell cup shaft. For this purpose, the bell cup shaft may include a conical receiving portion facing the spray bell and the spray bell may include a conical insertion portion facing the bell cup shaft. The conical insertion portion preferably has an inclination of 1° to 10°, for example 1° to 7°, more preferable about 3° or about 1° 26′ to 1° 30′, relative to the axis of rotation of the spray bell. Thus, in addition to the magnetic attachment, the spray bell can also be retained frictionally by static friction as a result of self-locking on the bell cup shaft.

This combination enables a particularly easy-to-use and secure attachment, which, however, can be released quickly and easily if necessary, even without tools. If the spray bell includes a shoulder on its outer surface, the spray bell can be detached from the bell cup shaft by means of a tool griping the spray bell, for example, with two tong-like tool halves. As a result, the spray bell can be captively retained in the tool and protected from damage even after it has been detached from the bell cup shaft.

Preferably, the conical insertion portion of the spray bell is designed such that the outer diameter of the insertion portion decreases in the direction from the spraying edge of the spray bell to the end of the spray bell facing the bell cup shaft. In other words, the receiving portion of the bell cup shaft grips the insertion portion of the spray bell in this embodiment. As an alternative to this, it is also possible for the receiving portion of the bell cup shaft to be inserted into the insertion portion of the spray bell according to the invention. In other words, the inner diameter of the insertion portion of the spray bell increases in the direction from the spraying edge of the spray bell to the end of the spray bell facing the bell cup shaft.

Due to the magnetic attachment, the spray bell is axially retained on the bell cup shaft in a secure manner, regardless of the rotation of the bell cup shaft. Damage caused by a spray bell accidentally falling off the bell cup shaft can thus be effectively avoided. On the other hand, however, the need to lift the spray bell from the housing with an excessive use of bearing air is eliminated. The use of bearing air can, thus, be reduced by more than half, usually even by more than two thirds to about 50 NL air, resulting in considerable savings in operating costs.

According to a preferred embodiment of the rotary atomizer, the ferromagnetic element is a ring provided on the side of the spray bell facing the bell cup shaft. Correspondingly, the bell cup shaft may include a central recess on the side facing the spray bell, in which the annular permanent magnetic element is fixed. This design is preferred for weight reasons. In principle, however, an inverse configuration with the permanent magnetic element on the spray bell and the ferromagnetic element on the shaft is also possible.

If the bell cup shaft is a hollow shaft, the permanent magnetic element can be secured in the shaft, for example, by the bell cup shaft including a shoulder on the side facing the spray bell comprising an axial contact surface facing away from the spray bell against which the annular permanent magnetic element is resting.

A deflecting member is usually inserted into the bell-shaped base body of the spray bell deflecting paint or a flushing agent that is supplied via a media line ending near the axis of rotation of the bell cup shaft, such that the paint or flushing agent is directed along the inside of the bell-shaped base body of the spray bell to the spraying edge. In conventional spray bells, to attach the deflecting member, an insert is often attached in the bell-shaped base body of the spray bell, usually pressed in, for the deflecting member to be fastened on. According to another exemplary embodiment of the present invention, this insert can be the ferromagnetic element that is provided, for example as a ring, on the side of the spray bell facing the bell cup shaft. For this purpose, the permanent magnetic element is provided on the bell cup shaft, for example near the end of the bell cup shaft facing the spraying edge.

Furthermore, the conical receiving portion and the conical insertion portion may be adapted to one another, such that there is an axial air gap of less than 2 mm, more preferable less than 1 mm, between the at least one ferromagnetic element and the at least one permanent magnetic element when the spray bell is attached in the bell cup shaft.

In addition to magnetically securing the spray bell on the bell cup shaft, the spray bell can be attached to the bell cup shaft by means of at least one additional loss prevention device in order to further minimize the risk of the spray bell falling off unintentionally. In this case, the loss prevention device can be formed by an elastic element, more preferable an O-ring or a spring lock washer, radially provided between the spray bell and the bell cup shaft. Alternatively or additionally, a loss prevention device may be formed by at least one element, more preferable a pin or a spring, that is slidably supported in a radial bore of the spray bell and is pressed into an (inner) groove of the bell cup shaft during rotation of the bell cup shaft.

In the following, advantageous embodiments of the invention will be explained in greater detail on the basis of examples and with reference to the drawings. In the drawings:

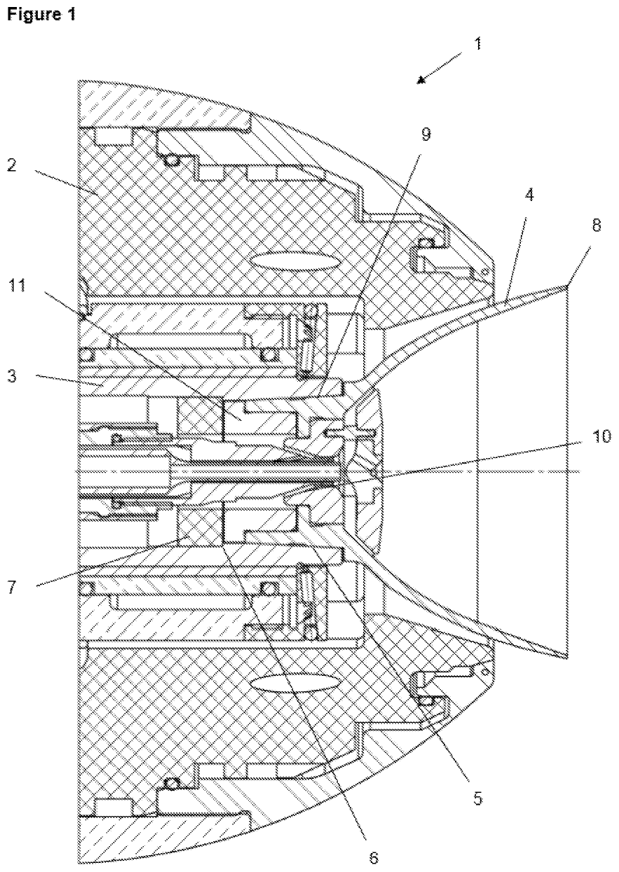

FIG. 1 shows a sectional view of a rotary atomizer according to a first embodiment of the invention;

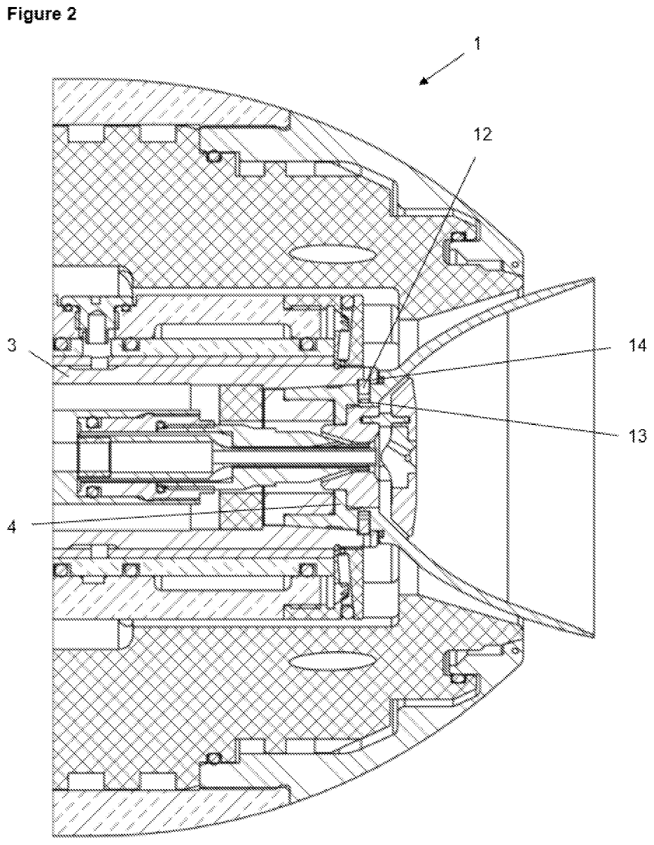

FIG. 2 shows a sectional view of a rotary atomizer according to a second embodiment of the invention;

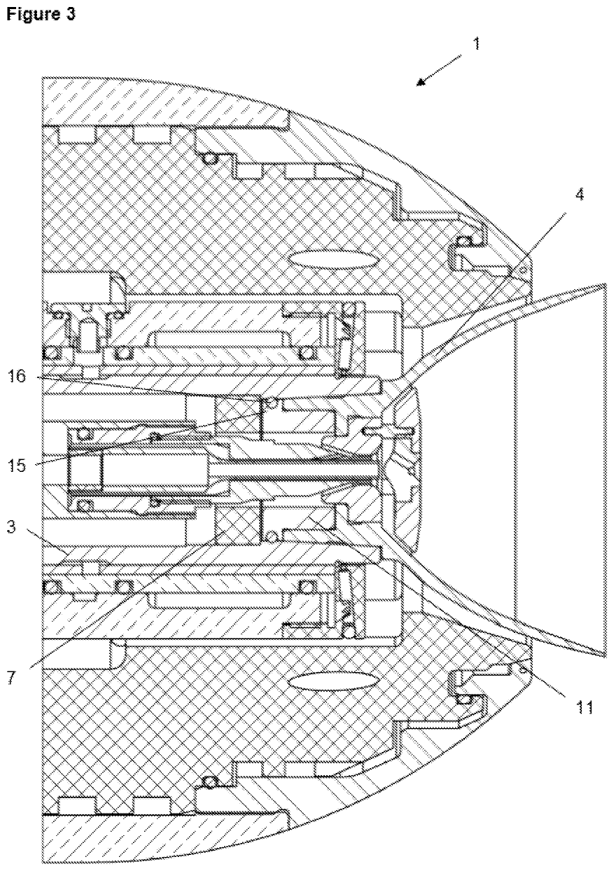

FIG. 3 shows a sectional view of a rotary atomizer according to a third embodiment of the invention;

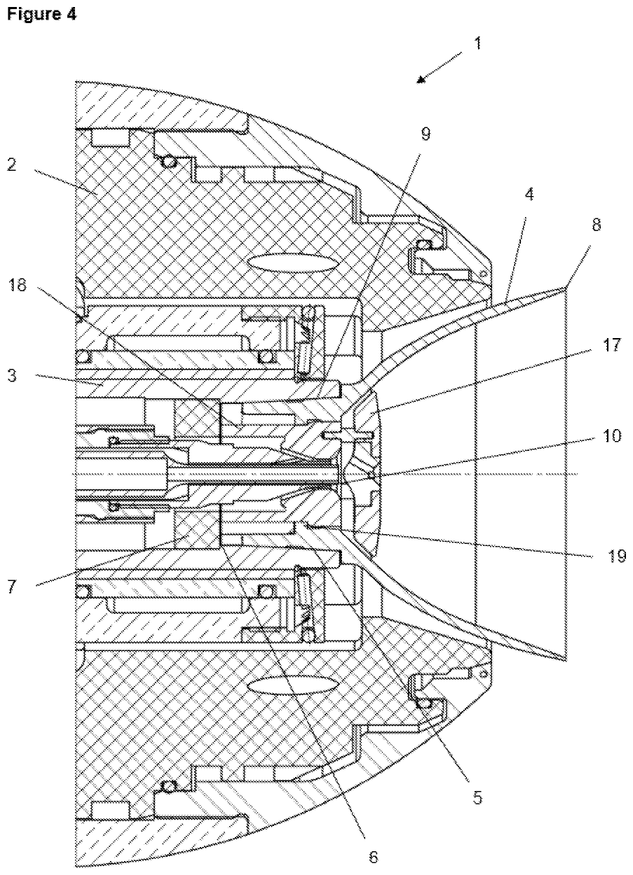

FIG. 4 shows a sectional view of a rotary atomizer according to a fourth embodiment of the invention; and

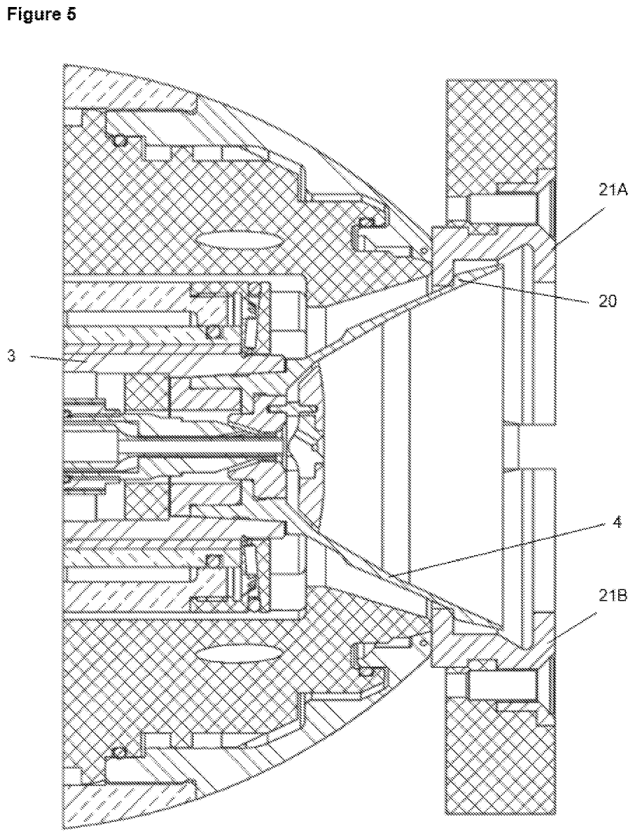

FIG. 5 shows a sectional view of a rotary atomizer according to a fifth embodiment of the invention.

Rotary atomizer 1 that is partially shown in FIG. 1 essentially includes a stationary housing 2, which may be movably attached to a robot arm (not shown), a bell cup shaft 3 rotatably supported therein and a spray bell 4 that is attached to bell cup shaft 3.

Bell cup shaft 3 is a hollow shaft including a conical receiving portion 5 on its side facing spray bell 4, which is inclined by 3° relative to the axis of rotation of bell cup shaft 3 in the example shown. Alternatively, it is possible for the conical receiving portion to be inclined by about 1° 26′ to about 1° 30′ relative to the axis of rotation, as in the case of a Morse taper. Thus, torque between bell cup shaft 3 and spray bell 4 may be transmitted, as with the Morse taper, by static friction as a result of the self-locking effect.

A shoulder comprising an axial contact surface 6 is formed in bell cup shaft 3 on the side of receiving portion 5 facing away from spray bell 4. A permanent magnetic ring 7 resting on contact surface 6 is fixed in bell cup shaft 3.

Spray bell 4 is made of aluminum, for example, and includes a bell body that increases in diameter towards a spraying edge 8 and includes a conical insertion portion 9 on its side facing bell cup shaft 3. Insertion portion 9 has an inclination relative to the axis of rotation that matches receiving portion 5, such that spray bell 4 can be centered and supported in bell cup shaft 3.

In principle, torque between bell cup shaft 3 and spray bell 4 may also be transmitted via static friction by inserting a conical receiving portion 5 of bell cup shaft 3 into an insertion portion 9 of spray bell 4 in a manner deviating from the illustration in FIG. 1.

Channels 10 are formed in spray bell 4 in order to direct paint that is to be atomized, air and/or a cleaning liquid, among others, to spraying edge 8. Furthermore, spray bell 4 is provided with a ferromagnetic ring 11 which, in the example shown, forms the end of spray bell 4 facing bell cup shaft 3. Ring 11 may include a shoulder, as shown, and is fastened in the bell body in a suitable manner, for example pressed in and/or glued in place.

When spray bell 4 is connected to bell cup shaft 3, as shown in FIGS. 1 to 3, permanent magnetic ring 7 and ferromagnetic ring 11 face each other with axial annular surfaces. Receiving portion 5 and insertion portion 9 are dimensioned in such a way that a minimum air gap remains between permanent magnetic ring 7 and ferromagnetic ring 11, such that the rings do not touch. However, they exert a magnetic force on one another acting in the axial direction, i. e. parallel to the axis of rotation, and thus, in addition to the frictional connection between receiving portion 5 and insertion portion 9, they retain spray bell 4 in bell cup shaft 3 in a captive manner. Unlike solutions known from the prior art, the magnetic force in the design according to the invention therefore acts exclusively or at least essentially exclusively in the axial direction, i. e. in the direction in which spray bell 4 is to be secured on the shaft.

Therefore, the disadvantages of high bearing air consumption known from the prior art are eliminated since spray bell 3 is securely retained on bell cup shaft 3, which is rotating in operation, by permanent magnetic ring 7 and ferromagnetic ring 11 but is not fixed on housing 2 and accordingly, it does not have to be lifted off with high use of bearing air.

The embodiment shown in FIG. 1 shows spray bell 4 being secured in bell cup shaft 3 by the frictional forces between insertion portion 9 and receiving portion 5 and the axial magnetic forces exerted by permanent magnetic ring 7 and ferromagnetic ring 11.

FIGS. 2 and 3 show alternative embodiments that are slightly modified compared to this embodiment and provide for an additional loss protection device between spray bell 4 and bell cup shaft 3.

In the embodiment shown in FIG. 2, this is accomplished by means of at least one pin 12 that is slidably supported in a radial bore 13 in spray bell 4 and able to engage a groove 14 in bell cup shaft 3. In this way, pin 12 is urged radially outwards and into engagement with groove 14 when the shaft rotates. When the shaft is at a standstill, pin 12 can slide back radially inwards in radial bore 13 in order to disengage from groove 14. Alternatively or additionally, the at least one pin 12 can be actively retracted radially inwards in radial bore 13 by means of a spring or the like when the shaft is at a standstill.

FIG. 3 shows an embodiment providing for a groove 15 in the outer surface of spray bell 4, in ferromagnetic ring 11 in the example shown, with an O-ring 16 being inserted therein, which is squeezed against the inner surface of bell cup shaft 3 to additionally secure spray bell 4 to bell cup shaft 3. As an alternative to O-ring 16, a spring lock washer or similar radially acting locking device may also be provided.

The embodiment of FIG. 4 differs from the embodiments of FIGS. 1 to 3 in that ferromagnetic ring 11 in spray bell 4 is replaced by an insert 18 supporting a deflecting member 17. Thus, it is no longer required to press insert 18 into spray bell 4 as is customary in the state of the art. Rather, insert 18 and spray bell 4 are retained magnetically on bell cup shaft 3. For this purpose, insert 18 can, as shown, be supported with a shoulder on a projection 19 in spray bell 4 protruding inwards in a flange-like manner. As shown, deflecting member 17 can be fastened to insert 18 by means of pins in order to deflect paint or a flushing agent from a channel 10 onto the inner surface of spray bell 4.

FIG. 5 shows another embodiment of the invention, wherein spray bell 4 is connected to bell cup shaft 3 as explained with reference to FIG. 1. However, the configuration of spray bell 4 in FIG. 5 is modified compared to the previous embodiments in that a shoulder 20 is formed on the outer surface of spray bell 4. This shoulder 20 allows using a tool 21, which is depicted in FIG. 5 as two tool halves 21A and 21B that are movable towards each other in a tong-like manner, for detaching spray bell 4 from bell cup shaft 3. Tool 21 is supported on housing 2 and grips spray bell 4 in such a way that spray bell 4 is lifted off bell cup shaft 3 against the force of magnetic connection 7, 11 (is pushed to the right in FIG. 5), whereby the magnetic forces decrease greatly as the distance between permanent magnetic ring 7 and ferromagnetic ring 11 increases, such that spray bell 4 can be easily detached from bell cup shaft 3. An additional advantage is that spray bell 4 is captively retained in tool 21 after it has been detached from bell cup shaft 3, such that damage to spray bell 4 after detachment may be avoided.

1. A rotary atomizer for coating components comprising:
a bell cup shaft (3) and a spray bell (4) that is regionally insertable into the bell cup shaft (3) and releasably attached to the bell cup shaft (3), wherein the spray bell (4) includes at least one ferromagnetic element (11, 18) or at least one permanent magnetic element (7) and the bell cup shaft (3) includes at least one permanent magnetic element (7) or at least one ferromagnetic element (11, 18) that are arranged in relation to one another such that the ferromagnetic element (11, 18) and the permanent magnetic element (7) exert a magnetic retaining force on one another acting parallel to the axis of rotation of the bell cup shaft (3) in order to releasably retain the spray bell (4) on the bell cup shaft (3), characterized in that the bell cup shaft (3) includes a conical receiving portion (5) facing the spray bell (4) and in that the spray bell (4) includes a conical insertion portion (9) facing the bell cup shaft (3), wherein the conical insertion portion (9) has an inclination of 1° to 10°, more preferable about 3° or about 1° 26′ to 1° 30′, relative to the axis of rotation of the spray bell (4).

2. The rotary atomizer according to claim 1, characterized in that the ferromagnetic element (11, 18) is a ring provided on the side of the spray bell (4) facing the bell cup shaft (3).

3. The rotary atomizer according to claim 1, characterized in that the ferromagnetic element (11, 18) is formed as an insert (18) that is axially supported on a projection (19) of the spray bell (4).

4. The rotary atomizer according to claim 3, characterized in that a deflecting member (17) for deflecting coating material onto the inner surface of the spray bell (4) is attachable to the insert (18).

5. The rotary atomizer according to claim 1, characterized in that the bell cup shaft (3) includes a central recess on the side facing the spray bell (4) in which recess the annular permanent magnetic element (7) is fixed.

6. The rotary atomizer according to claim 1, characterized in that the bell cup shaft (3) is a hollow shaft including a shoulder on the side facing the spray bell (4) comprising an axial contact surface (6) facing away from the spray bell (4) against which the annular permanent magnetic element (7) is resting.

7. The rotary atomizer according to claim 1, characterized in that the conical receiving portion (5) and the conical insertion portion (9) are adapted to one another such that there is an axial air gap of less than 2 mm, more preferable less than 1 mm, between the at least one ferromagnetic element (11) and the at least one permanent magnetic element (7) when the spray bell (4) is attached in the bell cup shaft (3).

8. The rotary atomizer according to claim 1, characterized in that the spray bell (4) is attached to the bell cup shaft (3) by means of at least one additional loss prevention device (12, 16).

9. The rotary atomizer according to claim 8, characterized in that the loss prevention device is formed by an elastic element, more preferable an O-ring (16) or a spring lock washer, radially provided between the spray bell (4) and the bell cup shaft (3).

10. The rotary atomizer according to claim 8, characterized in that the loss prevention device is formed by at least one element, more preferable a pin (12) or a spring, that is slidably supported in a radial bore (13) of the spray bell (4) and is pressed into a groove (14) of the bell cup shaft (3) during rotation of the bell cup shaft (3).

11. The rotary atomizer according to claim 1, characterized in that the spray bell (4) includes at least one shoulder (20) on its outer surface.
